(19) United States
(12) Patent Application Publication
(10) Pub. No.: US 2003/0161162 A1
(43) Pub. Date: Aug. 28, 2003

(54) Clear tail light

(76) Inventor: Tobin Tracey, Sandwich, MA (US)

Correspondence Address: Thomas Kahrl, P.O. BOX 1177, West Falmouth, MA, 02574, US

(21) Appl. No.: 10/238,563

(22) Filed: Sep. 10, 2002

Related U.S. Application Data
(60) Provisional application No. 60/359,315, filed on Feb. 25, 2002.

(51) Int. Cl. F21V 33/00

(52) U.S. Cl. 362/473; 362/541; 362/544

(57) ABSTRACT

A motorcycle taillight which is installed in the rear of a vehicle having a housing in which is mounted a conventional taillight bulb, covered by an inner lens insert having a conical dome like shape consisting of polycarbonate red material and over which is mounted an outer lens consisting of PMMA clear, translucent material including a grid diffuser portion, the housing having a panel having an interior metallized reflective surface surrounding the conventional taillight bulb, wherein said panel reflects white light when not illuminated, such the taillight presents a white/clear look when not illuminated. In particular the inner lens comprises a red colored insert formed of red colored translucent polycarbonate material formed in a dome shape is mounted to the base of the housing so as to cover the conventional taillight bulb and the conventional taillight bulb disposed within the red colored inner lens as mounted in said base is surrounded by the reflective interior metallized surface shaped in the form of a recessed cavity such that the taillight in this arrangement the will emit red colored light through the clear lens only when illuminated.

### “NONPROVISIONAL” APPLICATION

This is a complete “NonProvisional” Patent Application which is filed less than 12 months from the filing date of a “Provisional” application, which was filed Feb. 2, 2002.

### FIELD OF THE INVENTION (TECHNICAL FIELD)

The present invention relates to a taillight device for a vehicle which is installed on the rear of a vehicular body, that is normally clear but when illuminated emits a red light. More particularly, the present invention relates to a taillight having a clear, translucent outer lens in combination with an inner lens comprising a red cone insert superimposed on a taillight bulb intended to emit white light, for use on a motorcycle permitting a white/clear look when not illuminated and for emitting a red light for nighttime rearward illumination, or indication of stopping.

### DESCRIPTION OF RELEVANT ART

Taillights typically consist of a lamplight device for installation in the rear of a vehicle for use as a taillight, brake light, a stoplight or the like and incorporate a red colored outer lens in combination with a white taillight electric bulb for emitting red light. The characteristics of the red color for taillights are regulated by Federal regulation, namely SAE J578c. In the prior art an outer lens of a taillight for motorcycles typically incorporates its own color, for example red in cases of the taillight and the stoplight, so that the color tone of the taillight is red even if the bulb is turned off. Depending on the color tone of the body of a vehicle, the red lens of a taillight can be conspicuous and interrupts the appearance the vehicle. Some vehicles have amber LED or red LED arranged for a lamplight device, but in this case also the color tone of the place arranged with the LED is different from that of the vehicular body when the LED is turned off.

Accordingly, it is desirable to provide for a new and improved clear taillight to provide for imparting a clear look that does not distract from the color tone and appearance of the rear of the vehicle adjacent said taillight, when the red taillight is not lit and red color when illuminated, which overcomes at least some of the disadvantages of prior art.

### SUMMARY OF THE INVENTION

The present invention is directed to a taillight which is installed in the rear of a vehicle, typically a motorcycle, having a housing in which is mounted a conventional taillight bulb, covered by an inner lens insert having a conical/dome like shape consisting of polycarbonate red material and over which is mounted an outer lens consisting of PMMA clear, translucent material including a grid diffuser portion. The housing includes a generally asymmetrical base having a panel having a metallized reflective surface surrounding the conventional taillight bulb, wherein said panel reflects white light when not illuminated, such the taillight presents a white/clear look when not illuminated.

In the present invention, the inner lens comprising a red colored insert formed of red colored translucent polycarbonate material formed in a dome shape is mounted to the base of the housing so as to cover the conventional taillight bulb installed in a taillight mount provided on the rear bumper of the vehicle, namely a motorcycle. The conventional taillight is arranged to be disposed within the red-colored inner lens as mounted in said base to be surrounded by the reflective interior metallized surface shaped in the form of a recessed cavity, there being at least one opening in the reflective surface for the taillight bulb. In this arrangement, the present invention will emit red colored light through the clear lens when illuminated. In particular, the red light source in the present invention is a combination of a conventional clear taillight bulb, typically a 1157 (12 v 21/5 watt) bulb, a red insert having a conical shape mounted to the base of the taillight so as to cover the clear taillight bulb and a reflective base. When illuminated, clear taillight bulb in combination with the red insert and red light reflected by the reflective base emits red light through the clear, translucent lens. Accordingly in the present invention, emission of red light when the taillight is energized is determined by the light source and not the lens.

In an alternate embodiment of the invention includes a red cone insert having a dome portion and a reflective band at the base of said dome. The reflective band acts to reinforce the reflecting of white light by the reflective panel when not illuminated.

In order to achieve the above object, according to the present invention, there is provided a lamplight device for a vehicle comprising a taillight for a motorcycle comprising an asymmetrical housing having a unitary outer clear lens including a grid diffuser portion mounted to said housing; a reflective panel having at least one opening and a taillight bulb mounted in said base. In order to provide red colored light, there is provided a red cone insert comprising an intermediate lens between said light bulb and the clear lens for transmutation of white light to red light. The wall portion includes a reflective surface adapted to reflect white light to augment the clear feature of the taillight. In operation red light is emitted by the taillight when and is determined by the light source not the exterior lens.

The invention will be described for the purposes of illustration only in connection with certain embodiments; however, it is recognized that those persons skilled in the art may make various changes, modifications, improvements and additions on the illustrated embodiments all without departing from the spirit and scope of the invention.

### BRIEF DESCRIPTION OF THE DRAWINGS

The accompanying drawings, which are incorporated into and form a part of the specification, illustrate several embodiments of the present invention and together with the description serve to explain the principles of the invention. The drawings are only for the purpose of illustrating a preferred embodiment of the invention and are not construed as limiting the invention.

FIG. 1 is a rear perspective view of a motorcycle installed with the clear lamplight device according to the present invention;

FIG. 2 is a side view of the clear lamplight device according to the present invention;

FIG. 3 is an end view of the clear lamplight device shown in FIG. 2;

FIG. 4 is a partially exploded perspective view of with the clear lamplight device of FIG. 1 showing the reflective panel and the dual red domed intermediate lenses;

FIG. 5 is a schematic side view of the clear lamplight device; and

FIG. 6 is a schematic side view of an alternate embodiment clear lamplight device with clear lens removed showing the dual red domed intermediate lenses with silvered band;

FIG. 7 is a bottom view of the housing of the clear lamplight device shown in FIG. 2;

FIG. 8 is a top view of the housing clear lamplight device according to the present invention;

FIG. 9 is a schematic top view of the outer lens lamplight device shown in FIG. 2;

FIG. 10 is a schematic side view of the clear lamplight device according to the present invention; and;

FIG. 11 is an exploded schematic side view of the clear lamplight device according to the present invention without clear outer lens; and;

### DETAILED DESCRIPTION OF THE PREFERRED EMBODIMENTS

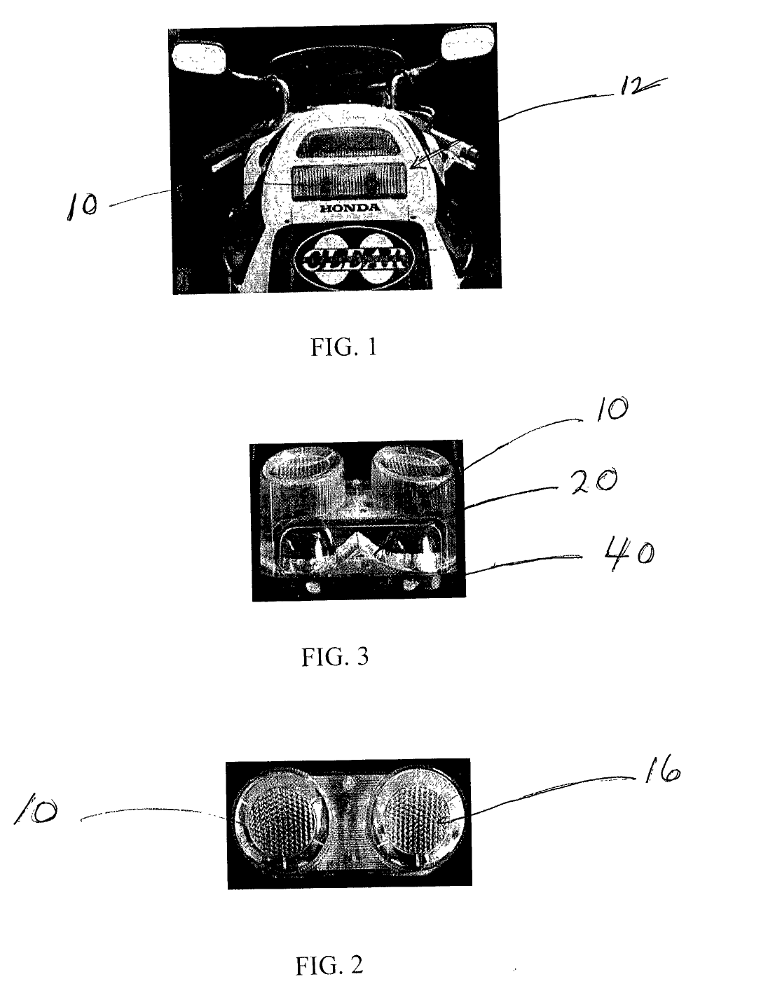

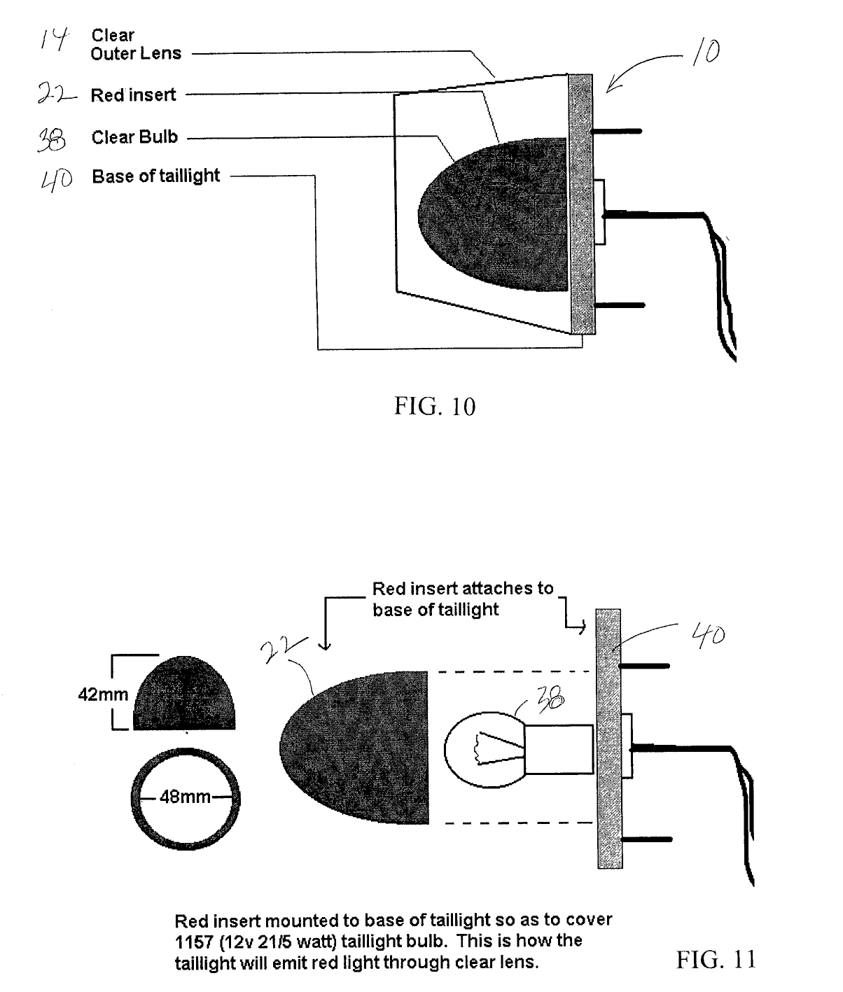

Hereinafter, an embodiment of the present invention will be described with reference to FIGS. 1 to 7 and 7 to 11. As is shown in FIG. 1, the preferred embodiment is directed to a taillight device 10 for a motorcycle 12 which is clear when it is turned off yet is red when turned on. The taillight device 10 comprises clear translucent outer lens 14 including a grid diffuser portion 16 mounted to a housing 18. As is shown in FIGS. 3, 4, 5 & 6 the housing 18 comprises a base 40 having an interior reflective panel 20 having a cavity 21 surrounding inner lens 22. As is shown in FIGS. 10 and 11 there is shown the inner lens 22 having a red colored dome portion 24, superimposed over a conventional taillight bulb 30. The taillight bulb 30 is configured to emit light when energized which is then transmuted from of white light to red light by the inner lens such that the red light emitted by the taillight 10 when illuminated is determined by the light source comprising a combination of the taillight bulb 30, the inner lens 22, the 34 reflective panel and the outer lens 14, as is shown in FIGS. 10 and 11.

Referring to FIG. 1 there is shown an outside view of an motorcycle 12 applied with lamplight device 10 of the embodiment viewed from rear wherein there is provided a clear look that does not distract from the color tone and appearance of the rear of the motorcycle adjacent said taillight, when the taillight is not illuminated.

Referring to FIGS. 1-7 there is shown the taillight 10 comprising an asymmetrical housing 18, a unitary translucent lens 14 including a grid diffuser portion 16 mounted to said housing. Said housing 18 includes a reflective cylindrical panel 20 having a wall portion 21 having a reflective surface 34 adapted to reflect white light having at least one opening 36 for receiving a red cone 22 having a dome portion 24 and a reflective band 26 at the base of said dome associated with the wall portion 21 of said reflective surface 34.

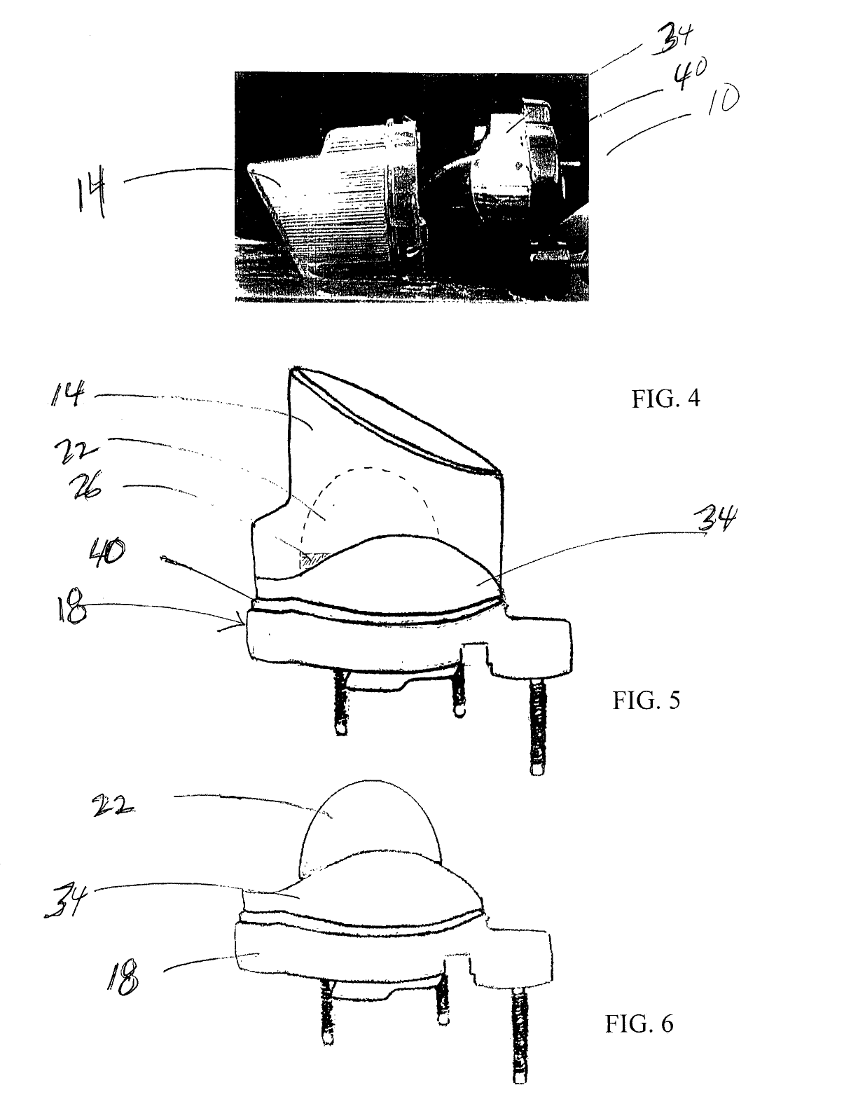

As is shown in FIG. 4 a light source 30 is disposed between said lens 14 and said housing 18 comprising a bulb 38 mounted in base 40 surrounded by the reflective panel 34 with at least one opening 36 of the reflective panel 34. As is further shown in FIGS. 4, 5 & 6 cavity 20 includes a reflective surface 34 adapted to reflect white light when not illuminated and red light when illuminated.

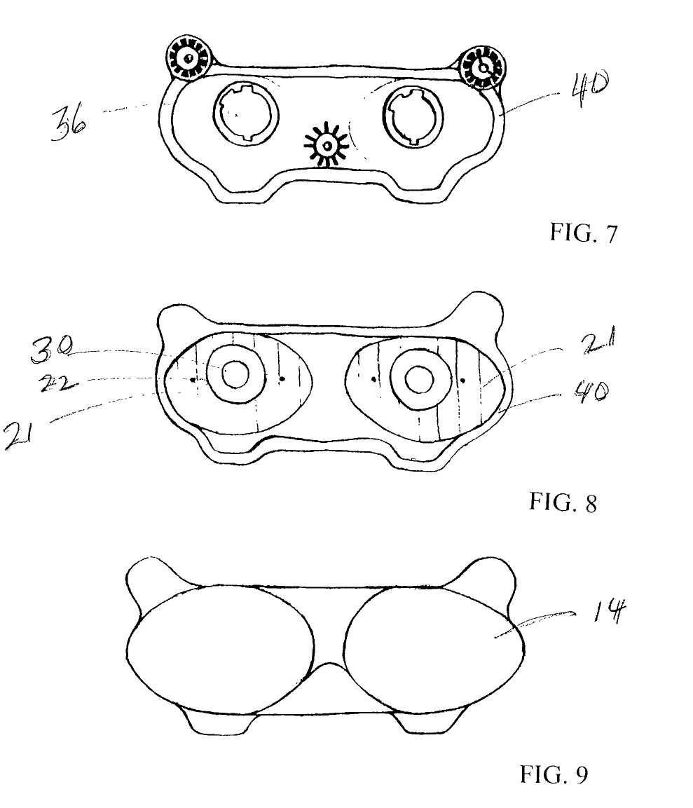

There is shown in FIG. 6 an alternate embodiment having a reflective band 26 at the base of said dome of inner lens 22 associated with the cavity 20 of reflective panel 34. The As is shown in FIGS. 7, 8 & 9 the taillight device 10 may include two taillight bulbs 38 between said outer lens 14 and said housing 18 comprising a dual light source, each light source 50 comprising a bulb 38 mounted in said base 40 in one of the dual openings 36 of the reflective panel configured to emit red light, each light source having a dome shaped partially reflective surface adapted to reflect white light.

What is claimed is:

1. A taillight for a motorcycle comprising:
an asymmetrical housing having;
a base for attachment to a motorcycle taillight mount over a taillight bulb affixed to said mount for emitting white light when illuminated; and
a reflective panel having an interior metallized surface for reflecting light surrounding at least one opening for said taillight bulb and for affixing an inner lens thereto;
an outer, unitary clear lens mounted to said housing;
the inner lens comprises a dome shaped, conical insert comprising red colored translucent material to the base surrounded by reflective panel so as to cover the taillight bulb and emit red colored light when illuminated;
wherein the taillight's light source comprises in combination the taillight bulb, the inner lens, the reflective panel and the outer lens; and
whereby when the taillight is not illuminated said panel reflects white light such the taillight presents a white/clear look and when illuminated, said clear taillight bulb in combination with the red insert and red light reflected by the reflective base emits red light through the clear, translucent lens wherein emission of red colored light when the taillight is energized is determined by the light source and not the outer lens.

2. The taillight of claim 1 wherein said outer lens is transparent except for the lens portion that includes a grid diffuser portion for diffusing light emitted.

3. The taillight of claim 1 wherein the reflective panel includes dual openings for accepting dual taillight bulbs and dual inner lenses for covering said bulbs.

4. The taillight of claim 1 wherein the inner lens insert comprising a red colored translucent material having a conical/dome like shape consisting of polycarbonate red material red insert having a conical shape mounted to the base of the taillight so as to cover the clear taillight bulb and a reflective base.

5. The taillight of claim 1 wherein the reflective panel employs a reflective surface adapted to reflect white light to augment the clear feature of the taillight when not illuminated such that the taillight in this arrangement the will emit red colored light through the clear lens only when illuminated.

6. A taillight for a motorcycle comprising:
an asymmetrical housing;
an outer lens comprising a unitary translucent lens including a grid diffuser portion mounted to said housing;
a reflective panel including a cavity having a metallic reflective surface adapted to reflect white light having at least one openings;
a inner lens comprising a red cone having a dome portion and a reflective band at the base of said dome associated with the cavity of said reflective panel; and
an illumination source enclosed by in said housing, comprising a taillight bulb mounted in said base surrounded by the reflective panel for emitting white light when illuminated, and said illumination source surrounded by the red cone of the inner lens whereby wherein the color of the light is emitted by the taillight when illuminated is determined by the light source not the outer lens.

7. The taillight device according to claim 6, wherein the light source between said lens and said housing comprises comprising a dual light source, each light source comprising a bulb mounted in said base in one of the dual openings of the reflective panel configured to emit red light, each light source having a dome shaped partially reflective surface adapted to reflect white light.

8. The taillight device to claim 6, further including a reflective panel and an appearance of the reflective surface of said panel member is visible through said clear lens when said illumination source is not projecting red colored light.

9. The taillight device to claim 6 wherein each taillight bulb is a red inner lens between said taillight bulb and the clear lens having; permitting a white/clear look when not illuminated and for emitting a red light for night time rearward illumination or indication of stopping wherein red light emitted by the taillight when illuminated is determined by the light source not the lens.
